(19) United States
(12) Patent Application Publication
(10) Pub. No.: US 2025/0208679 A1
(43) Pub. Date: Jun. 26, 2025

(54) INTEGRATED CIRCUIT INCLUDING AT LEAST TWO POWER SUPPLY DOMAINS CAPABLE OF BEING PLACED IN A RETENTION STATE, AND CORRESPONDING INTERLINKED METHOD OF POWER MANAGEMENT

(71) Applicant: STMicroelectronics International N.V., Geneva (CH)

(72) Inventors: Cyril Moulin, Aix En Provence (FR); Jean-Michel Gril-Maffre, Aix-en-Provence (FR); Herve Cassagnes, Salon-de-Provence (FR)

(21) Appl. No.: 18/925,842

(22) Filed: Oct. 24, 2024

(30) Foreign Application Priority Data
Dec. 21, 2023 (FR) 2314852

(51) Int. Cl. G06F 1/26

(52) U.S. Cl. CPC G06F 1/263

(57) ABSTRACT

An integrated circuit includes a logic part configured to be supplied by a main supply voltage, comprising an always-on first power supply domain, and at least two power supply domains that are deactivated in a retention state. The logic part includes auxiliary power supply lines configured to supply each deactivated power supply domain placed in the retention state of the always-on first power supply domain.

### CROSS-REFERENCE TO RELATED APPLICATIONS

This application claims the benefit of French Patent Application No. 2314852, filed on Dec. 21, 2023, which application is hereby incorporated herein by reference.

### TECHNICAL FIELD

Embodiments and implementations of integrated circuits, including in particular power supply domains capable of being deactivated and placed in a retention state, as well as a corresponding interlinked method of power management.

### BACKGROUND

Integrated circuits provide the option of a low power consumption mode, wherein the power consumption is reduced and tends to be minimized.

Typically, parts of the integrated circuit may be deactivated, in particular within a logic part, in order to limit the power consumption of the circuit, and also limiting certain functionalities of the circuit.

The logic part, or section or circuitry or components, of the circuit corresponds for example to the “core” of a processor, usually including synchronous (or “dynamic”) devices clocked on clock edges, such as combinational logic gates and flip-flops; and sequential (or “static”) devices clocked on clock levels, such as latches or registers.

Generally, to provide operation in a low-power mode, a power supply domain is provided that is always on and a power supply domain that can be deactivated and placed in a retention state.

A power supply domain corresponds for example to a set of circuits or functions using the same power supply in normal operation and being switched on or off at the same time.

In the retention state, the states (i.e. the data contained) of the sequential/static elements of the deactivated power supply domain are advantageously retained by a retention circuit (for example of the latch type), while the synchronous/dynamic logic elements and the combinational/dynamic logic elements are switched off.

However, in conventional low-power modes, the always on power supply domain continues its normal power consumption, in particular experiencing current leaks, and in a manner substantially proportional to the size of the always on power supply domain (i.e. substantially the number of functionalities remaining always on).

However, generally, the size of the always on power supply domain is limited in terms of reduction, due to the need for a minimum number of control elements enabling the deactivated power supply domain to be “woken up” and placed in the retention state.

Thus, in this type of integrated circuit, there is a need to further reduce power consumption in the low-power mode, particularly in terms of current leakage, while retaining the retention functionality, i.e. retaining the static data of the domain in the retention state.

### SUMMARY

According to one aspect, an integrated circuit includes a logic part comprising a first power supply domain, referred to as always on (known to the person skilled in the art as the always on power domain) capable of being powered by a supply voltage, and at least two power supply domains capable of being deactivated (i.e. for example disconnected from the supply voltage) and placed in a retention state, wherein the logic part includes auxiliary power supply lines for supplying retention circuitry (for example retention flip-flops or latches) of each deactivated power supply domain and placed in the retention state, with the supply voltage of the first always on power supply domain.

In other words, the integrated circuit according to this aspect can provide several degrees of low-power consumption, by deactivating a selection of one or more of the domains, the latter, placed in the retention state, all being powered by the always on power supply domain.

Consequently, it can be considered that the power supply domain containing the control elements for “waking up” the other deactivated power supply domain placed in the retention state, which is the always on domain in conventional cases, may, in the integrated circuit according to this aspect, also be deactivated and placed in the retention state.

Thus, the integrated circuit according to this aspect makes it possible for example to design the first always on power supply domain with a much smaller size and functionality than in conventional cases, comprising for example only auxiliary power elements and possibly control elements (in small quantities), capable of waking up the power supply domain containing the control elements (in larger quantities) making it possible to “wake up” the other power supply domain, so that the power consumption of the circuit is also lower.

According to one embodiment, the power supply domains capable of being deactivated and placed in the retention state are organized into hierarchical ranks, such that control circuitry, configured to control the deactivation and placement in the retention state or not of each domain of rank N respectively, belong to the domain of rank N−1; the control circuitry configured to control the deactivation and placement in the retention state or not of the domain of lowest rank belonging to another power supply domain.

In other words, in this organization, the power supply domains are “interlinked” from one to the next (N; N−1), particularly from the point of view of the functionality for managing and controlling the deactivation and placement in the retention state, as well as the functionality for managing and controlling the respective “wake-up”, i.e. the reactivation in the operating state of the respective domain.

According to one embodiment, the other power supply domain is the first always on power supply domain, or is another always on power supply domain supplied by another main supply voltage.

According to one embodiment, the logic part is configured to deactivate and place in the retention state the power supply domain of rank N, by a sequence comprising deactivations and placements of each power supply domain of high rank in the retention state, successively by decreasing ranks.

According to one embodiment, the logic part is configured to reactivate and remove from the retention state the power supply domain of rank N, by a sequence comprising reactivations and removing from the retention state of each power supply domain of lower rank, successively by increasing ranks.

According to another aspect, a method is also proposed for managing the power supply of an integrated circuit provided with a logic part including a first power supply domain, referred to as always on, powered by a supply voltage, and at least two power supply domains capable of being deactivated and placed in a retention state, in which the method comprises supplying each deactivated power supply domain placed in the retention state with the supply voltage of the first always on power supply domain.

For example, the method comprises disconnecting each power supply domain in the deactivated retention state from the supply voltage.

According to one embodiment, the power supply domains capable of being deactivated and placed in the retention state are organized in hierarchical ranks, such that each domain of rank J is deactivated and placed in the retention state or not, by commands from control circuitry belonging to the domain of rank J−1; the lowest rank domain being deactivated and placed in the retention state or not by commands from control circuitry belonging to another power supply domain.

According to one embodiment, the other power supply domain is the first always on power supply domain, or is another always on power supply domain powered by another main supply voltage.

According to one embodiment, the method comprises deactivating and placing in the retention state a power supply domain of rank J, by a sequence comprising deactivations and placing in the retention state of each power supply domain of higher rank, successively in decreasing ranks.

According to one embodiment, the method comprises reactivating and removing from the retention state a power supply domain of rank J, by a sequence comprising reactivations and removing from the retention state of each power supply domain of lower rank, successively in increasing ranks.

### BRIEF DESCRIPTION OF THE DRAWINGS

Other advantages and features of the invention will become apparent upon examining the detailed description of non-limiting embodiments and implementations, and from the accompanying drawings, wherein figures:

FIG. 1 illustrates an example of an integrated circuit in a run state;

FIG. 2 illustrates the integrated circuit of FIG. 1 in a low power mode;

FIG. 3 illustrates the integrated circuit of FIG. 1 in a very low power mode;

FIG. 4 illustrates a procedure for deactivating a power supply domain; and

FIG. 5 illustrates a procedure for reactivating the power supply domain.

### DETAILED DESCRIPTION OF ILLUSTRATIVE EMBODIMENTS

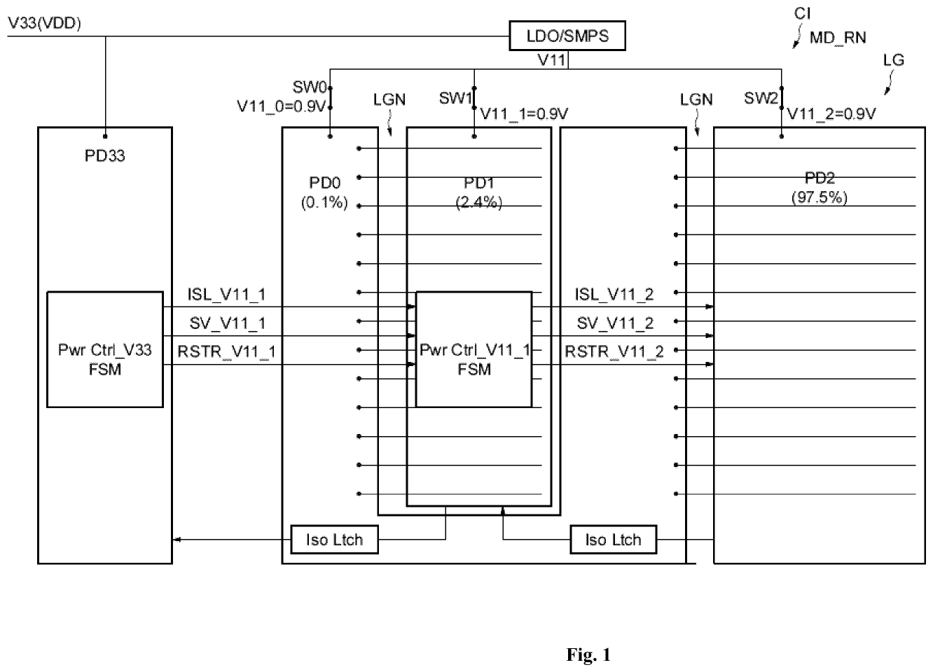

FIG. 1 illustrates an example of an integrated circuit IC in a run state MD_RN. The integrated circuit IC is for example a microcontroller, including a logic part LG, for example the core of a central processing unit. The logic part LG is subdivided into power supply domains PD0, PD1, PD2, PD33.

Each power supply domain PD0, PD1, PD2, PD33 corresponds for example to a set of circuits or functionalities of the logic part LG using the same power supply V11, V33 in normal operation and being switched on or off at the same time.

In this example a first supply voltage V33, usually denoted VDD, is supplied to the integrated circuit IC, for example from an external source.

From the voltage V33, a voltage regulator LDO/SMPS is configured to generate a voltage V11 adapted to the domains PD0, PD1, PD2 of the logic part LG.

Another domain PD33 may be provided to be powered directly by the voltage V33 (VDD), for example a domain implementing “analogue” functions such as input/output interfaces.

For example, the voltage V33 may be substantially 3.3 V, while the regulated supply voltage V11, referred to as the main supply voltage, may be substantially 1.1 V or less, for example 0.9 V.

The logic part LG includes an always on first power supply domain PD0, and (at least) two power supply domains capable of being deactivated and placed in a retention state PD1, PD2. The power supply domain PD33 may also be always on.

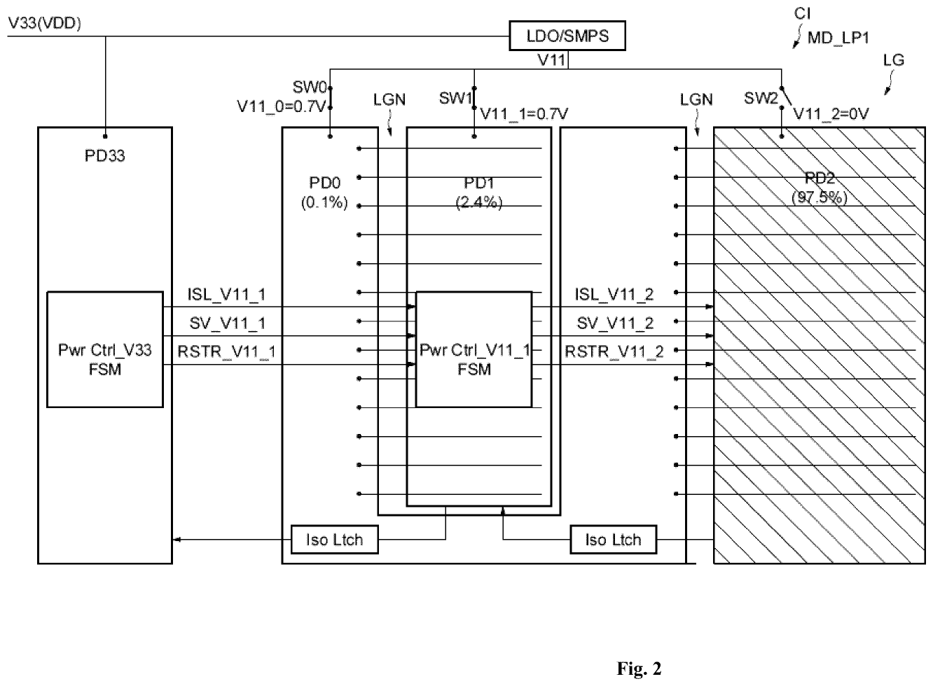

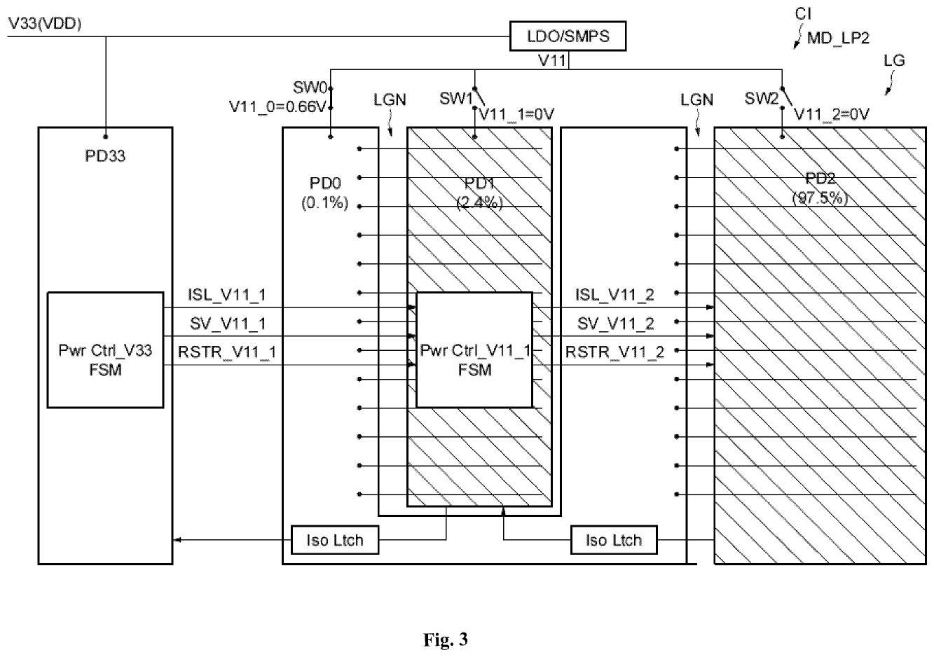

“Deactivated” means for example that the power supply domains PD1, PD2 are disconnected from the main supply voltage V11 (see FIGS. 2 and 3), usually by means of switch circuits SW0, SW1, SW2 connected between the voltage regulator LDO/SMPS and the respective power supply domains of the logic part LG.

In the retention state, the states (i.e. the data contained) of sequential elements, for example of the latch type, of the deactivated power supply domain PD1, PD2 are advantageously retained by retention circuitry, while the synchronous/dynamic logic elements are deactivated.

The retention circuitry, which is standard and known per se, may for example comprise as additional sequential/static circuit, for example of the latch type, configured to be in the same state (containing the same data) as a functional sequential device, and to be powered by an auxiliary power line LGN when the domain PD1, PD2 is deactivated.

In other words, the domains PD1, PD2 capable of being deactivated and placed in the retention state, include retention circuitry configured to retain a static state contained in the sequential elements of the respective domain PD1, PD2; the auxiliary power supply lines being configured to power the retention circuitry of the power supply domains.

Thus in this case the logic part LG includes auxiliary power supply lines LGN configured to supply each deactivated power supply domain in the retention state PD1, PD2 with the supply voltage V11_0 of the always on first power supply PD0.

Consequently, the integrated circuit IC benefits from several degrees of low power use MD_LP1, MD_LP2 (see FIGS. 2 and 3), by providing the option of deactivating and placing in the retention state a selection of one or more of the domains PD1, PD2, powered by the always on power supply domain PD0.

The latter can be referred to as the “first domain in the retention state” PD1 (which will be duly distinguished from the “first” always on domain PD0, even if there is no mention of “in the retention state”), and “second domain in the retention state” PD2.

Reference is now made to FIG. 2.

FIG. 2 illustrates the integrated circuit of FIG. 1, in a low power mode MD_LP1.

In the low power mode MD_LP1, the second domain PD2 is deactivated and placed in the retention state, whereas the first domain in the retention state PD1 is kept in an operating state powered by the main supply voltage V11.

The second domain PD2 is no longer powered by the main supply voltage V11 and is for example disconnected from the LDO/SMPS controller by the respective open switching circuit SW2.

The retaining circuitry of the second domain PD2 is powered, via the auxiliary power supply lines LGN, with the supply voltage V11_0 of the first always on power supply domain PD0.

For example, the main supply voltage V11 supplied to the first always on domain PD0 and to the first domain PD1, can be lowered to 0.7 V in the low power mode MD_LP1.

In order to implement the deactivation and the retention functionality of the second power supply domain PD2, commands ISL_V11_2, SV_V11_2, RSTR_V11_2 are initiated in an activated power supply domain PD1.

The first retention state domain PD1 includes control circuitry PwrCtrl_V11_1, configured to control the deactivation and placement in the retention state of the second retention state domain PD2; as well as the reactivation or waking up of the second domain PD2 in the operating state, i.e. removed from the deactivated retention state.

The control circuitry PwrCtrl_V11_1 are for example incorporated into control circuitry of the state machine type FSM of the first domain PD1, and are configured to generate at least:

an isolation control signal ISL_V11_2 capable of controlling the isolation of the retention circuits of the retention circuitry of the second domain PD2;

a back-up signal SV_V11_2 capable of controlling a capture of the current static state in the second domain PD2, by the retention circuitry, which will be retained during the retention state; and

a reset signal RSTR_V1_2 capable of controlling a return to the operating state, i.e. waking up from the retention state of the second domain PD2.

Reference is now made to FIG. 3.

FIG. 3 illustrates the integrated circuit of FIGS. 1 and 2, in a very low power mode MD_LP2.

In the very low power mode MD_LP2, the second domain PD2 is deactivated and placed in the retention state, and the first domain PD1 is also deactivated and placed in the retention state.

The first domain DP1 and the second domain PD2 are no longer powered by the main supply voltage V11 and are for example disconnected from the LDO/SMPS controller by the respective open switching circuits SW1, SW2.

The retention circuitries of the first domain PD1 and the second domain PD2 are powered, via the auxiliary power supply lines LGN, with the supply voltage V11_0 of the always on first power supply domain PD0.

For example, the main supply voltage V11 supplied to the first always on domain PD0 can be lowered to 0.66 V in the very low power mode MD_LP2.

Similarly to the second domain PD2, in order to implement the deactivation and retention functionality of the first power supply domain PD1, commands ISL_V11_2, SV_V11_2, RSTR_V11_2 are initiated in an always on power supply domain PD33 (or PD0).

Thus, control circuitry PwrCtrl_V33 is configured to control the deactivation in the retention state of the first domain PD1; as well as the reactivation or waking up of the first domain PD1 in the operating state, i.e. from the deactivated retention state.

The control circuitry PwrCtrl_V33 is for example incorporated into a state machine type controller FSM of an always on power supply domain. This always on power supply domain may be for example the power supply domain PD33 powered by the external voltage V33 (VDD); or alternatively, the first always on power supply domain PD0.

The control circuitry PwrCtrl_V33 is also configured to generate at least:

an isolation control signal ISL_V11_1 capable of controlling the isolation of the retention circuits of the retention circuitry of the first domain PD1;

a back-up signal SV_V11_1 capable of controlling a capture of the current static state in the first domain PD1, by the retention circuitry, which will be retained during the retention state; and

a recovery signal RSTR_V1_1 capable of controlling a return to the operating state, i.e. waking up from the retention state of the first domain PD1.

In summary, with N=2 in FIGS. 1, 2 and 3, the power supply domains capable of being deactivated and placed in the retention state PD1, PD2 are organized in N hierarchical ranks.

The hierarchy is designed such that the control circuitry PwrCtrl_V11_J−1, configured to control the deactivation and placement in the retention state and reactivation from the retention state, of each domain of rank J respectively (PD2, for J=N=2), belongs to the domain of lower rank J−1 (PD1, for J=N=2).

The control circuitry PwrCtrl_V33 configured to control the deactivation and placement in the retention state and the reactivation from the retention state of the lowest rank domain PD1, belongs to another power supply domain, either the first always on power supply domain PD0, or the other always on power supply domain PD33 powered by the voltage V33, i.e. another main power supply voltage.

The integrated circuit IC described in connection with FIGS. 1, 2 and 3 makes it possible for example to design the first always on power supply domain PD0 with a minimal size and minimal functionality, so as to have extremely low power consumption, particularly in the very lower power mode MD_LP2.

The domain which can be deactivated and placed in the lowest rank retention state PD1 may also be configured to have a size which tends to be minimized, so as to have a reduced power consumption, particularly for the low consumption mode MD_LP1.

For example, the second retention state domain PD2 can include the vast majority of the functionalities of the logic part LG powered by the main supply voltage V11; whereas the first retention state domain PD1 can include only some functionalities of the logic part, and the function of the control circuitry PwrCtrl_V11_1.

The functionalities implemented by the first domain PD1 can be functionalities relating to the waking up of the second domain PD2, for example derived from digital circuitry or software, for example derived from operations for decoding information communicated on a data bus.

The functionalities of the second domain PD2 may represent for example more than 95% of the logic part supplied by the main supply voltage V11, for example 97.5%.

The functionalities of the first domain PD1 may represent less than 5% of the logic part (powered by the main supply voltage V11), for example 2.4%.

The first always on domain PD0 may represent a marginal portion of the logic part powered by the main supply voltage V11, for example 0.1%. For example, the functionality of the first always on domain PD0 may include only the transmission of the power supply voltage V11_0 on the auxiliary power supply lines LGN.

Furthermore, given the small amount of functionality of the first domain PD1, the control circuitry PwrCtrl_V33 controlling the retention state of the first domain PD1, is realized proportionally in a small quantity. Its consumption in the operating state is also proportionally low.

Thus, the control circuitry PwrCtrl_V33 provided to control the retention state of the first domain PD1, has a much lower consumption than the control circuitry PwrCtrl_V11_1 provided to control the retention state of the second domain PD2.

This applies both in the case where the control circuitry PwrCtrl_V33 is implemented in the always on domain PD33 supplied by an external supply voltage V33; and in the case where it is implemented in the always on domain PD0 powered by the main supply voltage V11.

As a result, in the very low consumption mode MD_LP2, the deactivation in the retention state of the first domain PD1 provides a tangible and non-negligible gain in terms of reducing power consumption, relative to the low consumption mode MD_LP1.

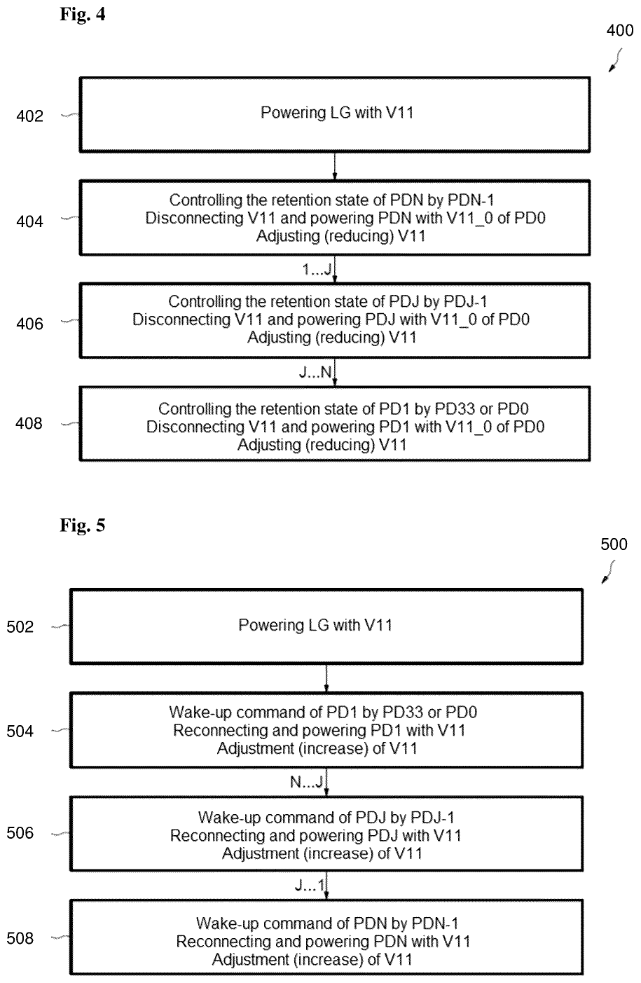

FIG. 4 illustrates a procedure 400 for deactivating the power supply domain PDJ of rank J, implemented in a method for managing the power supply of the integrated circuit IC described above in relation to FIGS. 1 to 3.

The method for managing the power supply comprises firstly powering 402 the logic part LG of the integrated circuit with a main supply voltage V11.

And, to implement a deactivation 406 of a power supply domain of rank J in the retention state, the procedure 400 comprises a sequence of successive deactivation and placing in the retention state 404 of each power supply domain of higher rank, in decreasing ranks N . . . J.

Thus, to deactivate the domain PDJ (with 1<J≤N) in step 404 firstly the domain PDN of highest rank N is deactivated.

Step 404 thus includes generating control signals placing the PDN domain in the retention state, and initiated in the lowest rank domain PDN−1.

The domain PDN is disconnected from the main supply voltage V11, and the retention circuitry of PDN are powered by the voltage V11_0 of the always on power supply domain PD0.

Optionally, the main supply voltage V11 (powering the always on power supply domain PD0) can be reduced, for example from V11=0.9 V to V11=0.7 V.

This step is carried out for all domains N . . . J of rank higher than J.

Then, the domain PDJ of rank J (with 1<J≤N) is deactivated in a step 406.

Step 406 thus includes generating control signals, placing the domain PDJ in the retention state, and initiated in the lower rank domain PDJ−1.

The domain PDJ is disconnected from the main supply voltage V11, and the retention circuitry PDJ are powered by the voltage V11_0 of the always on power supply domain PD0.

Optionally, the main supply voltage V11 (powering the always on power supply domain PD0) can be reduced, for example from V11=0.9 V to V11=0.7 V.

Beyond the domain of rank J, the lowest rank domain PD1 can be deactivated, in step 408, after having deactivated any domains in ranks between J and 1 (J . . . 1).

From another point of view, before deactivating the lowest rank domain PD1, steps 404-406 are implemented as described above, with J=2.

The lowest rank domain PD1 is deactivated and placed in the retention state in a step 408, including generating control signals placing the domain PDJ in the retention state, and initiated in the always on domain PD33.

The domain PD1 is disconnected from the main supply voltage V11, and the retention circuitry of PD1 is powered by the voltage V11_0 of the always on power supply domain PD0.

Optionally, the main supply voltage V11 (supplying the always on power supply domain PD0), for can be reduced for example from V11=0.7 V to V11=0.66 V.

It should be noted that with N=2 and J=1, the implementation of the method 400 is illustrated by the sequence of FIGS. 1, 2 and 3.

FIG. 5 illustrates a procedure 500 for reactivating the power supply domain PDJ of rank J, implemented in a method for managing the power supply of the integrated circuit IC described previously in relation to FIGS. 1 to 3.

The method of managing the power supply firstly comprises powering 502 the logic part LG of the integrated circuit with a main supply voltage V11.

And, in order to perform a reactivation 506 of a rank J power supply domain from the retention state, the procedure 500 comprises a sequence of successive reactivations and removing from the retention state 504 of each power supply domain of lower rank, in increasing ranks 1 . . . J.

Thus, to reactivate the domain PDJ (with 1<J≤N) firstly the lowest rank domain PD1 is reactivated in step 504, if this domain was deactivated.

Step 504 thus includes generating wake-up control signals from the retention state of domain PD1, initiated in the always on domain PD33.

The domain PD1 is reconnected to the main supply voltage V11 which supplies all of the functionalities of the domain PD1.

Optionally, the main supply voltage V11 can be increased, for example from V11=0.66 V to V11=0.7 V.

All of the domains of rank between 1 and J are reactivated by successive steps 506 each including generating wake-up control signals from the retention state of the domain PDJ, initiated in the lower rank domain PDJ−1.

The domain PDJ is reconnected to the main supply voltage V11, which powers all the functionalities of the domain PDJ.

Optionally, the main supply voltage V11 can be increased, for example from V11=0.7 V to V11=0.9 V.

Similarly, to reactivate the domain PDN of the highest rank in step 508, all of the domains of rank between J and N are reactivated, by successive steps 506 each including generating wake-up signals from the retention state of the domain PDJ, initiated in the lower rank domain PDJ−1.

In step 508 the domain PDN is reconnected to the main supply voltage V11, which supplies all of the functionalities of the domain PDN.

Optionally, the main supply voltage V11 can be increased, for example from V11=0.7 V to V11=0.9 V.

What is claimed is:

1. An integrated circuit comprising:
at least two second power supply domains configured to be deactivated and placed in a retention state, each second power supply domain comprising retention circuitry; and
a logic part comprising an always-on first power supply domain configured to be powered by a supply voltage, wherein the logic part includes auxiliary power supply lines configured to power, with the supply voltage of the always-on first power supply domain, the retention circuitry of each deactivated second power supply domain placed in the retention state.

2. The integrated circuit according to claim 1, wherein the power supply domains are organized in hierarchical ranks, and the integrated circuit further comprises control circuitry configured to control the deactivation and placement in the retention state or not of each domain of rank J, respectively, wherein the control circuitry belongs to a lower rank domain J−1 and is configured to control the deactivation and placement in the retention state or not of a lowest rank domain belonging to another power supply domain.

3. The integrated circuit according to claim 2, wherein the another power supply domain is the always-on first power supply domain.

4. The integrated circuit according to claim 2, wherein the another power supply domain is another always-on power supply domain supplied by another main supply voltage.

5. The integrated circuit according to claim 2, wherein the logic part is configured to deactivate and place in the retention state the power supply domain of rank J, by a sequence comprising deactivations and placements in the retention state of each power supply domain of higher rank, successively in decreasing ranks (N . . . J).

6. The integrated circuit according to claim 2, wherein the logic part is configured to reactivate and place out of the retention state the power supply domain of rank J, by a sequence comprising reactivations and removals from the retention state of each power supply domain of lower rank, successively in increasing ranks (1 . . . J).

7. The integrated circuit according to claim 2, configured to selectively deactivate and place in the retention state one or more of the power domains to provide multiple degrees of low-power consumption.

8. A method for managing power of an integrated circuit having a logic part including an always-on first power supply domain, and having at least two second power supply domains, the method comprising:
powering the always-on first power supply domain with a supply voltage;
deactivating and placing in a retention state one or more selected second power supply domains; and
powering, by auxiliary power supply lines of the logic part, retention circuitry of each deactivated power supply domain placed in the retention state, with the supply voltage of the always-on first power supply domain.

9. The method according to claim 8, further comprising organizing the power supply domains into hierarchical ranks, such that each domain of rank J is deactivated and placed in the retention state or not, by commands from the lower rank domain J−1, a lowest rank domain being deactivated and placed in the retention state or not by commands issued by another power supply domain.

10. The method according to claim 9, wherein the another power supply domain is the always-on first power supply domain.

11. The method according to claim 9, wherein the another power supply domain is another always-on power supply supplied by another main supply voltage.

12. The method according to claim 9, further comprising deactivating and placing in the retention state a power supply domain of rank J, by a sequence comprising deactivating and placing in the retention state each power supply domain of higher rank, successively in decreasing ranks (N . . . J).

13. The method according to claim 9, further comprising reactivating and removing from the retention state a power supply domain of rank J, by a sequence comprising reactivations and removing from the retention state of each power supply domain of lower rank, successively in increasing ranks (1 . . . J).

14. The method according to claim 9, further comprising selectively deactivating and placing in the retention state one or more of the power domains to provide multiple degrees of low-power consumption.

15. An integrated circuit comprising:
at least two second power supply domains configured to be deactivated and placed in a retention state, each second power supply domain comprising retention circuitry;
a logic part comprising an always-on first power supply domain configured to be powered by a supply voltage, wherein the logic part includes auxiliary power supply lines configured to power, with the supply voltage of the always-on first power supply domain, the retention circuitry of each deactivated second power supply domain placed in the retention state; and
control circuitry configured to selectively deactivate and place in the retention state one or more of the power domains to provide multiple degrees of low-power consumption.

16. The integrated circuit according to claim 15, wherein the power supply domains are organized in hierarchical ranks, and the control circuitry is configured to control the deactivation and placement in the retention state or not of each domain of rank J, respectively, wherein the control circuitry belongs to a lower rank domain J−1 and is configured to control the deactivation and placement in the retention state or not of a lowest rank domain belonging to another power supply domain.

17. The integrated circuit according to claim 16, wherein the another power supply domain is the always-on first power supply domain.

18. The integrated circuit according to claim 16, wherein the another power supply domain is another always-on power supply domain supplied by another main supply voltage.

19. The integrated circuit according to claim 16, wherein the logic part is configured to deactivate and place in the retention state the power supply domain of rank J, by a sequence comprising deactivations and placements in the retention state of each power supply domain of higher rank, successively in decreasing ranks (N . . . J).

20. The integrated circuit according to claim 16, wherein the logic part is configured to reactivate and place out of the retention state the power supply domain of rank J, by a sequence comprising reactivations and removals from the retention state of each power supply domain of lower rank, successively in increasing ranks (1 . . . J).
